(19) United States
(12) Patent Application Publication
(10) Pub. No.: US 2013/0129579 A1
(43) Pub. Date: May 23, 2013

(54) COLORIMETRIC METHOD AND DEVICE FOR DETECTING ANALYTE QUANTITIES IN FLUIDS AND MATERIALS

(71) Applicants: Anna Moore, Dracut, MA (US); Zdravka Medarova, Methuen, MA (US); Subrata Ghosh, Braintree, MA (US)

(72) Inventors: Anna Moore, Dracut, MA (US); Zdravka Medarova, Methuen, MA (US); Subrata Ghosh, Braintree, MA (US)

(73) Assignee: The General Hospital Corporation, Boston, MA (US)

(21) Appl. No.: 13/806,197

(22) PCT Filed: Jun. 23, 2011
(86) PCT No.: PCT/US11/41630

§ 371 Date: Jan. 26, 2013

Related U.S. Application Data
(60) Provisional application No. 61/358,530, filed on Jun. 25, 2010.

(51) Int. Cl. G01N 21/78

(52) U.S. Cl. CPC G01N 21/78
USPC 422/426; 422/69; 422/425

(57) ABSTRACT

A method and device for detecting an analyte in a solution or compound mixture use colorimetric detection to detect the quantity of an analyte in the solution or compound. The analyte sensor demonstrates a clear change in peak light absorption wavelength as a function of the stoichiometric relationship between the analyte sensor and the analyte. The method involves combining the analyte sensor and the analyte in solution and observing a color change of the mixture. Additionally, predefined amounts of the analyte sensor can be added until color change is detected and the quantity of analyte can be determined as a function of the total amount of analyte sensor in the mixture. Alternatively, a device having multiple wells or compartments, each with a different concentration of the analyte sensor. The analyte sample can be introduced to each well and the well that demonstrates the color change can, from its know analyte sensor concentration, be used to quickly and accurately determine the concentration of the analyte.

### CROSS-REFERENCE TO RELATED APPLICATIONS

This application claims any and all benefits as provided by law of U.S. Provisional Application No. 60/358,530 filed Jun. 25, 2010, which is hereby incorporated by reference in its entirety.

This application is related to U.S. application Ser. No. 61/233,179, filed on 12 Aug. 2009, which is hereby incorporated by reference in its entirety.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

The present invention is direct to a method and device for detecting an analyte in a solution or compound mixture. Specifically, the invention is directed to methods and devices for colorimetric detection of the quantity of an analyte.

2. Description of the Prior Art

Many analyte materials, such as metals and bio-molecules, play an important role in many biological functions of the body and can be found in known quantities in various organs and fluids in the body. Changes in the quantities or levels of these materials can signal the onset of disease. One example of such a material is Zinc. Hich amounts of zinc can be found in the pancreas, retina, brain and prostate. The ability to detect and quantify zinc in biological fluids can play an important role in early diagnosis of various diseases (for example, prostate cancer) and in assistance with therapy (for example, testing insulin secretory capacity of pancreatic islets prior to transplantation).

Prior methods to detect materials, such as zinc, in biological fluids involved the use of light sensing equipment (for example, fluorimeter), which can be expensive and not practical for personal use or use in some clinical settings. These systems involve a sensor, for example, a zinc sensor, that is adapted to bind to one or more analyte molecules or units, resulting in an increase in fluorescence intensity that can be detected by a fluorescence measuring device such as a fluorimeter. Fluorometry or spectrofluorometry typically involves using a beam of light, such as ultraviolet light, that excites the electrons in molecules of certain compounds and causes them to emit light of a lower energy, typically, but not necessarily, visible light. These methodologies can be expensive as specialized equipment may be needed to measure the fluorescence and detect analytes.

### SUMMARY

The present invention is directed to a colorimetric method and device for detecting analytes, including but not limited to zinc, calcium, ketones, glucose, protein, and bilirubin, in biological fluids using a previously unknown feature of the sensor described in U.S. application Ser. No. 61/233,179 as well as other analyte sensors. The device can be used for sensing of analytes, including but not limited to zinc, that can be easily adapted for personal (as well as clinical) use. The device does not require the use of optical sensing equipment or the need for calibration and can be used to provide low cost sensing in diverse environments.

In specific embodiments, the invention includes a sensor molecule or compound that exhibits a change in light absorption wavelength upon binding to the analyte at a predefined stoichiometry. In accordance with one embodiment of the invention, the sensor can be provided in solution at a predefined concentration in one or more discrete portions, such as wells or pockets, of a device and a solution containing the analyte under test can be introduced to one or more of the discrete portions (e.g., wells or pockets). The user can observe a distinct color change of the solution in the one or more discrete portions, in the wells or pockets, to indicate that the concentration of the analyte is proportional to the concentration of the sensor.

In one embodiment, the sensor can be provided in solution at a predefined concentration in one or more wells or pockets of a device and a solution containing the analyte under test can be introduced to one or more of the wells or pockets. After waiting a predefined amount of time for the analyte to bind to the sensor, a user can check for a color change. If no color change is observed, then a predefined amount of sensor can be added to one or more wells or pockets and after a waiting a predefined amount of time, the user can check for a color change. This process can be repeated until a color change is observed and the user can determine the concentration of the analyte as a function of the initial concentration of the sensor and the amount of sensor added up to the point that the color change is observed.

In one embodiment, the sensor can be provided in solution at two or more different concentrations in two or more wells or pockets of a device and a solution containing the analyte under test can be introduced to each of the wells or pockets containing the sensor solution. After waiting a predefined amount of time for the analyte to bind to the sensor, a user can check the wells or pockets for a color change, the well or pocket having a different color than the others indicating the concentration of the analyte.

In an alternative embodiment, the sensor molecule or compound can be provided at two or more different concentrations in a dry pad or other carrier material in two or more discrete portions of a device and a solution, containing the analyte under test, can be introduced to each of the discrete portions the sensor. The solution can be absorbed by the pad material allowing the analyte to bind to the sensor in each discrete portion. After waiting a predefined amount of time for the analyte to bind to the sensor, a user can check the discrete portions of the device for a color change, the discrete portion having a different color than the others indicating the concentration of the analyte.

In accordance with one embodiment of the invention, a zinc sensor has been found to exhibit a change in absorption wavelength upon binding to zinc at a known stoichiometry. In the absence of zinc, a solution of the sensor has a known absorbance peak, corresponding to a specific red color. Upon addition of a defined concentration of zinc chloride (ZnCl₂), equal to 2× the sensor concentration, the solution undergoes a shift in the absorbance peak towards a shorter wavelength. This is demonstrated by a sharp change in the color of the solution to intense green. Further addition of the sensor leads to a return of the absorbance peak to the wavelength characteristic of the sensor without zinc, resulting in the return of the original red color of the solution.

In an alternative embodiment of the invention, analyte quantification is made possible by a different sensor that undergoes a progressive shift in absorbance peak from ˜590 nm to ˜640 nm, as increasing amounts of zinc are titrated in the solution. After a defined molar ratio of zinc to sensor is achieved (1:1), the absorbance profile begins to change back to the zinc-unsaturated state. This shift is accompanied by a color change from purple to blue and back to purple, with a peak in blue color at a 1:1 molar ratio of zinc to sensor.

One application of this discovery is the accurate quantification of analyte (zinc) concentration, based on the described changes in light absorbance properties. This is because these changes are distinctly characteristic of a defined analyte concentration. This discovery can be used in an assay for the determination of zinc concentration in seminal fluid. Titration of the sensor compound into a 1:20 dilution of seminal fluid, resulted in an absorbance shift and the appearance of an intense green color. Further addition of the sensor caused a return to baseline absorbance values allowing an estimate of the zinc concentration in the seminal fluid to be ˜1.2 mM. The sensor compound was used to detect the quantity of mobile reactive zinc, and the detected amount was consistent with the known concentration of zinc in seminal fluid [Saaranen, 1987 #2].

The mechanisms behind the observed phenomenon are not obvious. It is believed that in order to have the described properties, a sensor needs to possess distinct molecular states (linked to distinct detectable physicochemical properties such as absorbance, fluorescence, solubility, etc.) depending on the number of sensor-bound analyte molecules, and the molecular state of the sensor bound to one analyte molecule is drastically different from the molecular state of the sensor with two analyte molecules bound. The balance between these distinct molecular states depends on the concentration equilibrium between sensor and analyte in solution. As an example, in the described application, an excess of zinc at a low concentration of sensor is insufficient to generate the intense green color described above because of low signal. An excess of sensor at a low concentration of zinc, shifts the chemical equilibrium towards sensor bound to just one molecule of analyte (a state characterized by a red color and a longer-wavelength). Intense green color is only present at sensor saturation by zinc, i.e. when two zinc molecules are bound to one sensor molecule.

In accordance with implementations of the invention, one or more of the following capabilities may be provided.

The invention provides for a method or device for detecting a predefined quantity of an analyte without the need for fluorescence or optical sensing equipment.

The invention provides for a method or device for detecting a predefined quantity of an analyte that does not require calibration.

The invention provides for a method or device for detecting a predefined quantity of an analyte that is accurate, low cost and easy to use.

These and other capabilities of the invention, along with the invention itself, will be more fully understood after a review of the following figures, detailed description, and claims.

### BRIEF DESCRIPTION OF THE FIGURES

FIG. 1 shows the color change of one sensor medium according to an embodiment of the invention.

FIG. 2 shows the structure of a zinc sensor according to an embodiment of the invention.

FIG. 3 shows the color change of an alternate sensor medium according to an embodiment of the invention.

FIG. 4 shows the color change of a zinc sensor medium combined with seminal fluid according to an embodiment of the invention.

FIG. 5 shows a diagram of a device including a multi-well plate for detecting analyte concentrations according to an embodiment of the invention.

FIG. 6 shows a diagram of a method for using a device including a multi-well plate for detecting analyte concentrations according to an embodiment of the invention.

FIG. 7 shows an alternate embodiment of FIG. 5, which includes magnifying glass tops on each well of the multi-well plate.

FIG. 8 shows a diagram of a device including a test strip for detecting analyte concentrations according to an embodiment of the invention.

FIG. 9 shows a diagram of a microdialysis device including multiple wells for detecting analyte concentrations according to an embodiment of the invention.

FIG. 10 shows the binding of a zinc sensor in a range of different analyte concentrations, which show the distinct green color.

### DETAILED DESCRIPTION OF PREFERRED EMBODIMENTS

The present invention is directed to a method and a device for analyte quantification in fluids that can be used in the clinic as well as in a home setting. The device can be accurate, low cost and easy to use. The device can utilize a colorimetric principle to measure analyte concentration based on its reaction with an analyte sensor.

The present invention is directed to methods, devices and systems that include an analyte sensor that can be used to indicate the analyte concentration based upon light absorbance or fluorescence. In accordance with the invention, the analyte sensor compound can include one or more binding center(s) for the analyte. In addition, upon binding with analyte, the sensor compound can change its conformation resulting in a shift in absorbance/fluorescence wavelength and/or a change in signal intensity. For example, the user can observe a distinct color change without the need for optical sensing or imaging equipment.

For purposes of illustration, several embodiments of the present invention are described in the context of measuring zinc concentration. However, the present invention can be used with any sensor that changes its reporting properties upon binding with the analyte under test.

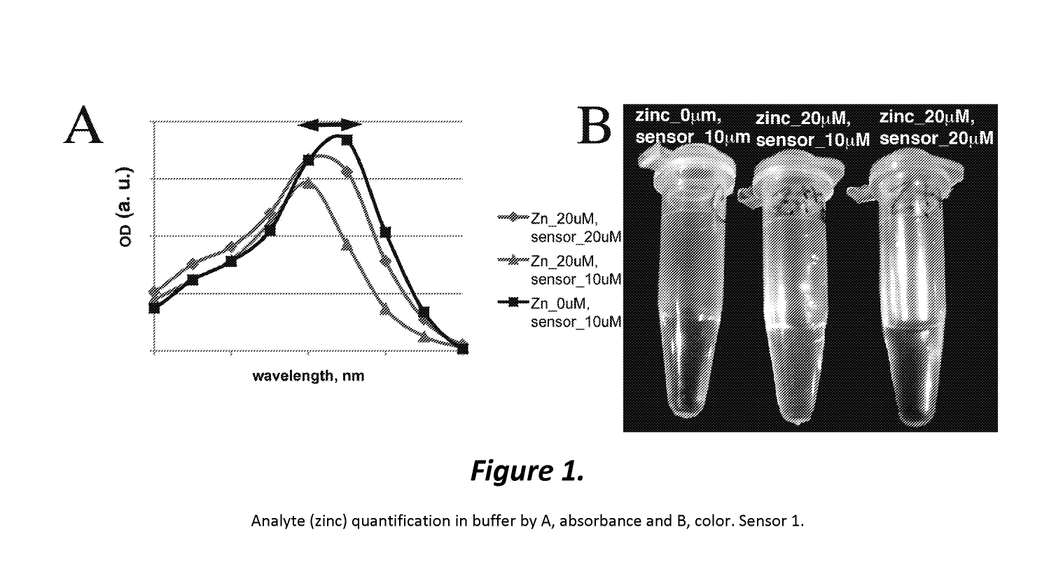

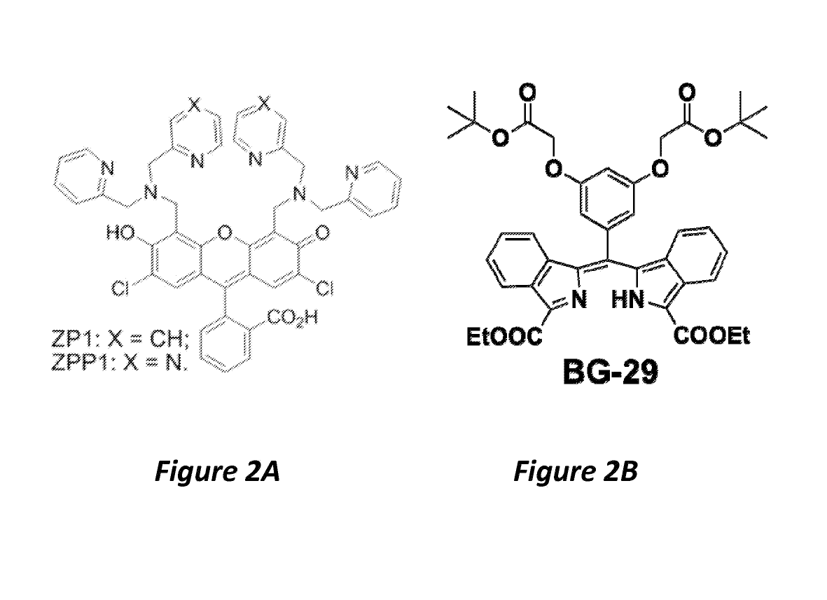

In accordance with one embodiment of the invention, a zinc sensor (e.g. ZPP1) exhibits a change in absorption wavelength upon binding to zinc at a defined stoichiometry. In the absence of zinc, a solution of the sensor has a defined absorbance peak as shown in FIG. 1A, corresponding to a specific (red) color as shown FIG. 1B. Upon addition of a defined concentration of zinc chloride (ZnCl₂), equal to 2× the sensor concentration, the solution undergoes a shift in the absorbance peak towards a shorter wavelength as shown in FIG. 1A. This is accompanied by a sharp change in the color of the solution from red to intense green as shown in FIG. 1B. The addition of the sensor to the solution leads to a return of the absorbance peak to the wavelength characteristics of the sensor without zinc as shown in FIG. 1A, accompanied by a corresponding return of the original red color of the solution as shown in FIG. 1B. The structure of the zinc sensor ZPP1 is shown in FIG. 2A.

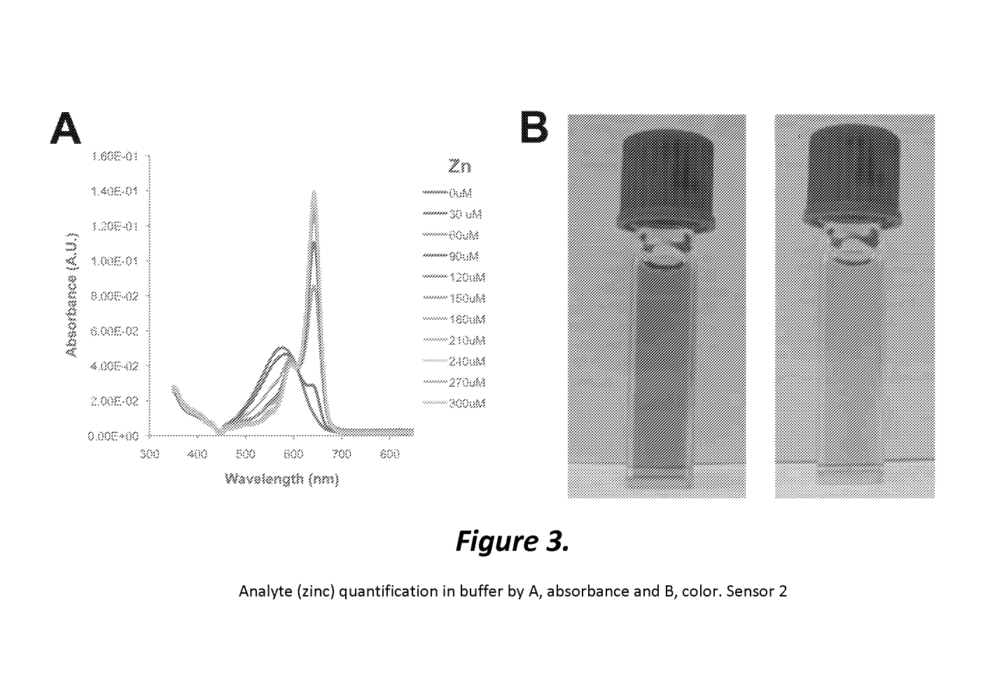

An alternative method for analyte quantification can be accomplished using a different sensor, BG-29, shown in FIG. 2B that undergoes a progressive shift in absorbance peak from ˜590 nm to ˜640 nm, as increasing amounts of zinc are titrated in the solution (FIG. 3A). After a defined molar ratio of zinc to sensor is achieved (1:1), the absorbance profile begins to change back to the zinc-unsaturated state (FIG. 3A). This shift is accompanied by a color change from purple to blue and back to purple, with a peak in blue color at a 1:1 molar ratio of zinc to sensor.

In accordance with embodiments of the invention, these sensor compounds can be used for the accurate quantification of analyte (e.g., zinc) concentration, based on the observed changes in light absorbance. This is because these changes correspond to a defined analyte concentration based on the known concentration of the sensor. In one embodiment, the invention was used to determine the zinc concentration in seminal fluid using one sensor (ZPP1).

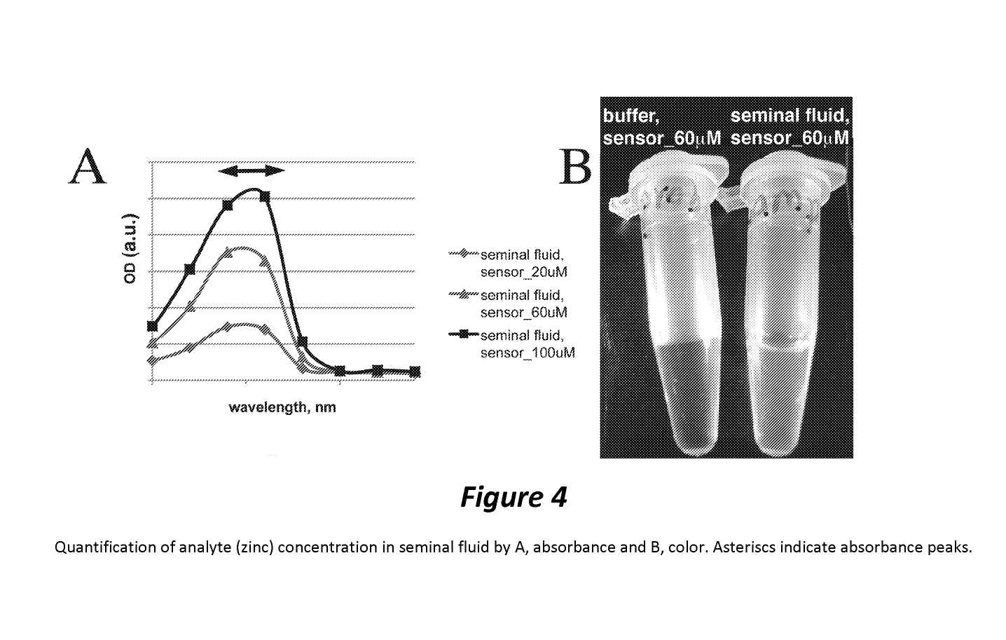

In accordance with one embodiment of the invention, titration of the sensor compound into a 1:20 dilution of seminal fluid resulted in an absorbance shift as shown in FIG. 4A and the appearance of an intense green color as shown in FIG. 4B. Further addition of the sensor caused a return to baseline absorbance values as shown in FIG. 4A. In this embodiment of the invention, the zinc concentration in the seminal fluid was estimated to be ˜1.2 mM. This sensor compound can be used to detect mobile reactive zinc and the detected amount is consistent with the known concentration of zinc in seminal fluid [Saaranen, 1987 #2].

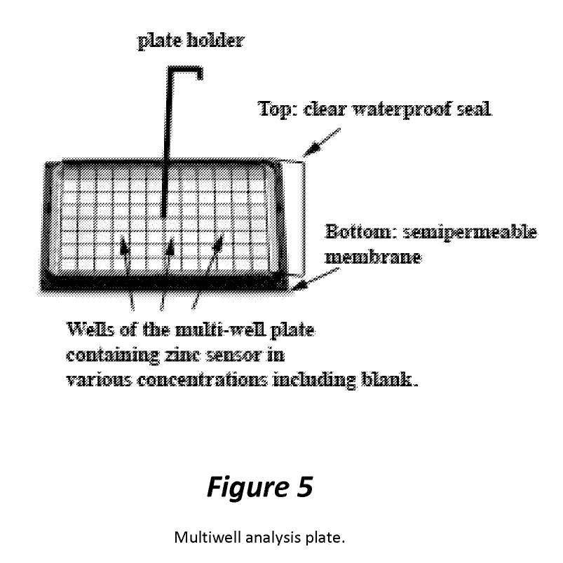

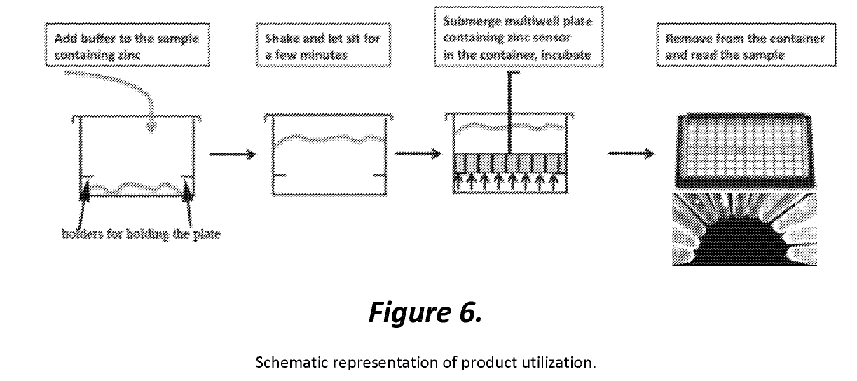

In accordance with one embodiment of the invention, as shown in FIGS. 5 and 6, a sensing device can include a multi-well plate containing wells with a sensor solution or dry formulation at different concentrations including a blank or empty well. The plate can be sealed from the top with a transparent or translucent seal, such as using a clear, waterproof plastic material. The plate can be sealed at the bottom with any permeable material (for example a semi-permeable membrane) sufficient to allow the analyte in solution to enter the wells as shown in FIGS. 5 and 6. Upon collection of a sample in the container, the plate can be submerged in the sample (the sample can be diluted if needed). The sample can diffuse through the membrane and react with the sensor compound. Upon reaching equilibrium, green color will develop in the well corresponding to the analyte concentration. The concentration or other information about the test can be printed on clear plastic material, the top of the plate or the walls of the wells.

A method for using the invention is shown in FIG. 6. The sample containing the analyte is put into a container and a buffer solution can be added to dilute the sample to a known concentration, if needed. The mixture can be shaken and allowed to sit in order to provide for uniform dilution. The multi-well plate can be inserted into the container allowing the permeable membrane to be submerged in the solution and allowing the analyte solution to diffuse into each of the wells. After a predefined incubation time, the multi-well plate can be removed and read. The color change (or different color well) indicating the concentration of the analyte.

In some embodiments of the invention, it might be necessary to shine regular (white) light on or through the plate for better visualization. In other embodiments, other colors of light can be used to enhance readability of the color change. In other embodiments, the wells or the plate can selected from a color that provides better visualization. Precise analyte concentration in biological fluid could be then deduced from a known concentration of a sensor in a well, which develops, in this example, an intense green color.

In other embodiments of the invention, the color change can be enhanced by introducing additional compounds to the initial content of the well that would serve as a color enhancer (FRET-like reaction, etc).

In other embodiments of the invention, the color change and visualization can be enhanced by precipitating the final product.

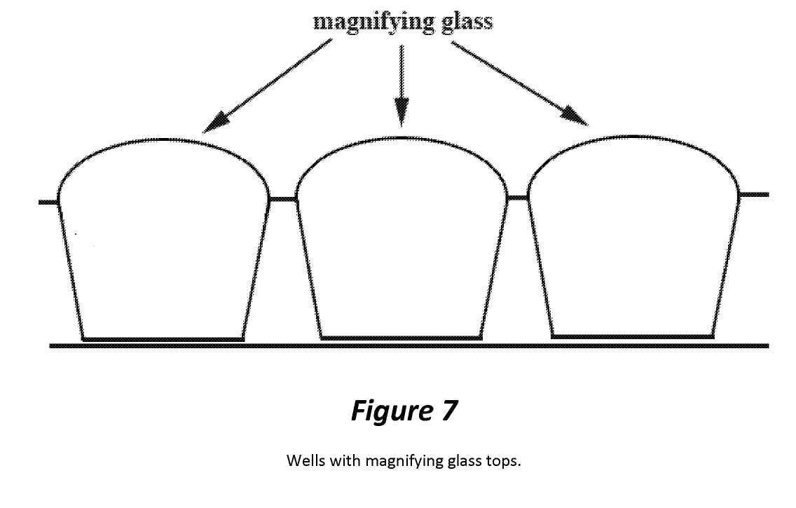

In other embodiments of the invention, the color change visualization can be enhanced by providing magnifying glass covers for each well as shown in FIG. 7, or glass with polarizing properties which can enhance detection signaling (e.g., green) color.

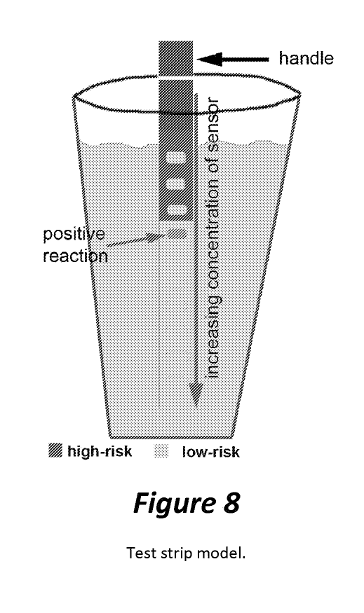

In an alternative embodiment of the invention, the device can take the form of a test kit that can include a test strip as shown in FIG. 8. The test strip can include a plastic base to which reagent pads (discrete portions) pre-filled with known concentrations of the sensor compound can be positioned in predefined locations along the base. For example, the concentrations can increase along one dimension of the test strip. Alternatively, the concentrations can vary along one or more dimensions of the test strip or the test sheet. In accordance with some embodiments of the invention, the reagent pads can be composed of an absorbent layer affixed to the plastic base and underlying a reagent-filled compartment (50-200 μl volume) enclosed in a permeable membrane, for example a dialysis membrane, of a 100 Da cut-off (FIG. 8). The 100 Da cut-off will retain the sensor inside the compartment but allow small analyte ions, such as zinc, to diffuse across the membrane and into the compartment where a reaction will take place. Alternatively, the reagent pads can include an absorbent layer affixed to the base that includes an absorbed, predefined quantity of the sensor compound (in either wet, moist or dry form). The patient can be instructed to submerge the test strip in a test sample (prostatic fluid, seminal fluid, or urine) for approximately 30 sec to 1 min. The test strip can include indicia of risk or concentration levels and the result provides a standardized visible color indication of risk or analyte levels. The base of the test strip can also be colored to enhance visualization of the color change. In some embodiments of the invention, the color of the discrete portions can then be visually compared to the included color chart to determine the level of analyte. The pre-loaded sensor can be dissolved in appropriate buffer (liquid) or it can be lyophilized (solid). The plastic base can be formed from a solid or flexible material.

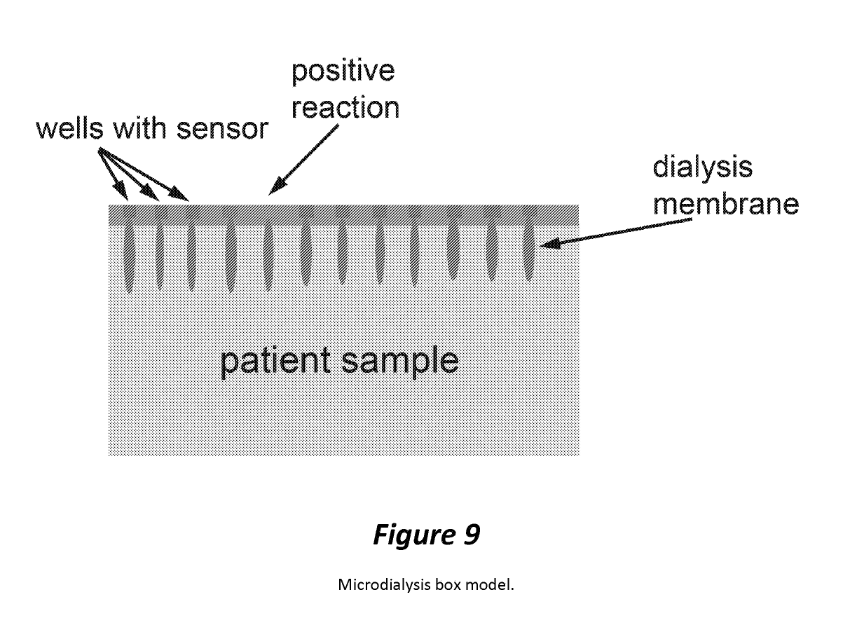

In an alternative embodiment, the invention can be provided in kit form, such as a microdialysis test kit including a two-compartment box as shown in FIG. 9. The underlying compartment can hold the sample produced by the patient. The upper compartment can include a multi-well plate that is sealed on the top and has a bottom composed of 100 Da cut-off dialysis bags submerged in the patient sample. The wells of the upper compartment can contain the sensor medium (different concentrations in the different wells). After the patient fills the bottom chamber with the test sample, the upper chamber can be reconnected or brought in contact with the bottom chamber, the entire box can be swirled gently for 30 sec to 1 min, following which the color can be read and compared to an included color chart. The top surface of the wells can include indicia indicating a level of risk or a concentration level based on the concentration of the sensor in the adjacent well.

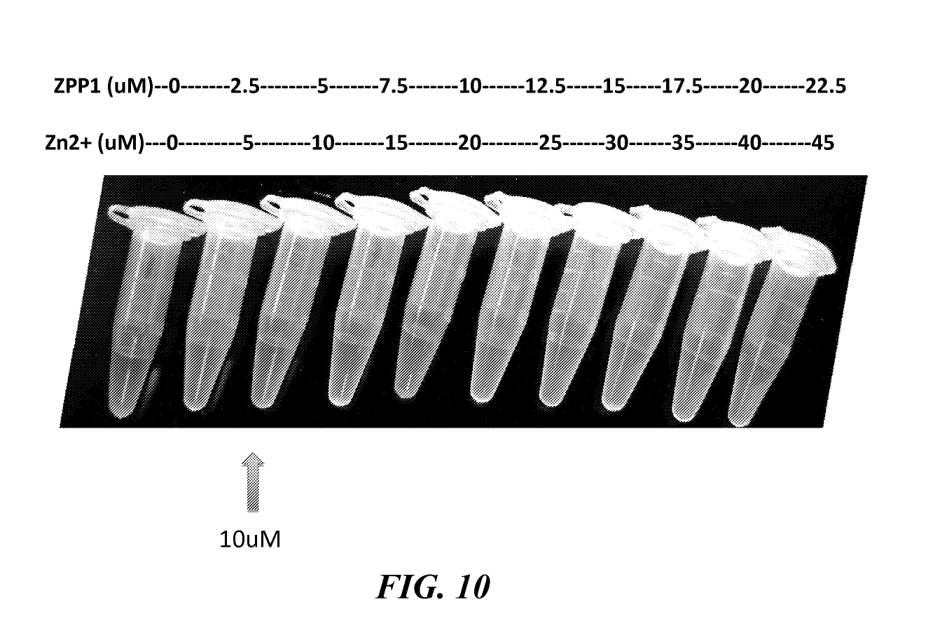

FIG. 10 shows, in accordance with some embodiments of the invention, the range of concentrations that can be detected. In this embodiment, a range of concentrations of a sample analyte was aliquotted into ten 1.5 ml eppendorf tubes with the following zinc chloride concentrations: 0, 5, 10, 15, 20, 25, 30, 35, 40, and 45 (uM). Then, zinc sensor compound (Zpp1) solution according to the invention was added to the corresponding tubes in the following concentrations: 0, 2.5, 5, 7.5, 10, 12.5, 15, 17.5, 20, and 22.5 (uM). FIG. 10 shows a gradual increase (low to high concentration of zinc) of bright green fluorescence. With the unaided eye, the green color is detectable for concentrations as low as 10 uM zinc (Zpp1 concentration of 5 uM).

In accordance with the invention, many different sensor materials can be used. The sensors have the properties that when bound in specific stoichiometric relationships with the analyte produce a detectable change in peak light absorption wavelength. Thus, when exposed to ordinary white light or specific colors of light, a user can easily detect a change in color indicating that the analyte has a stoichiometric relationship with the analyte sensor from which the analyte concentration can be accurately determined.

Devices using these sensors can be used to detect concentration levels of analytes, including metals (for example, zinc and calcium) and other biological molecules, such as ketones, glucose, proteins, and bilirubin. The detection of concentration levels of these materials can be used in the early detection of cancers and other diseases.

### EXAMPLES

In accordance with one embodiment a test strip or a multi-well plate can be used to detect zinc levels in prostatic fluid and urine. In these embodiments, the wells or compartments can be configured and arranged to detect zinc concentrations in the range of 1-10 mM. In one embodiment, the device can include 20 compartments including the zinc sensor in concentrations ranging from 0.5 to 10 mM, with approx. 500 microM increments. These devices can be used for early detection of prostate cancer and other diseases.

In an alternative embodiment, for detecting zinc in EPS urine, the range of detection can be 10 to 50 microM and the device can include 20 wells including the zinc sensor in concentrations ranging from 5 to 50 mM, with approx. 2.5 microM increments.

In other embodiments, the device can be used to detect analyte concentrations in other materials, such as soil. In this embodiment, a volume or mass of soil can be washed or diluted in a buffer solution and then exposed to the analyte sensor solution. In accordance with one embodiment, the soil sample can be air dried and screened, for example through a 10 mesh stainless steel sieve, and a predefined mass (for example, 10 g) or a predefined volume (for example, 10 mL) can be combined with an extracting solution (for example, 20 ml of DTPA or 0.1M HCl extracting solution). Using a reciprocating or rotating shaker, the soil and the extracting solution can be shaken at 180 or more epm for 2 hours. The extracting solution can be separated from the mixture by filtering, (for example using Whatman No. 42 or No. 2 filter paper or similar grade filter paper. Measured samples of the extracting solution can be applied to a 10 or 20 well plate containing the zinc sensor in a range of concentrations.

Other embodiments are within the scope and spirit of the invention. Further, while the description above refers to the invention, the description may include more than one invention.

What is claimed is:

1. A detecting device comprising an analyte sensor that exhibits a predefined change in absorption wavelength, only at a specific stoichiometry of the analyte sensor and the analyte.

2. The detecting device according to claim 1 further comprising at least one well including an analyte sensor compound at a predefined concentration.

3. The detecting device according to claim 1 further comprising a plurality of wells, each well including an analyte sensor compound at a predefined concentration.

4. The detecting device according to claim 3 wherein at least two of the plurality of wells have different concentrations of the analyte sensor compound.

5. The detecting device according to claim 1 wherein the analyte is zinc and the analyte sensor is ZPP1.

6. The detecting device according to claim 1 wherein the analyte is zinc and the analyte sensor is BG-29.

6. The detecting device according to claim 1 wherein the analyte sensor compound has a concentration of at least 10 micro molar.

7. A device for quantifying an analyte concentration, the device comprising
a plurality of wells covered by a permeable membrane, each well including a predefined concentration of an analyte sensor compound; and
wherein the analyte sensor compound distinctly changes color at a predefined stoichiometric relationship with an analyte.

8. The device according to claim 7 wherein the concentration of the analyte sensor compound in a first well is different from the concentration of the analyte sensor compound in a second well.

9. The device according to claim 7 wherein each well includes an analyte sensor compound in a predefined concentration and the concentration increases along one dimension of the device.

10. The device according to claim 7 wherein each well includes an analyte sensor compound in a predefined concentration and the concentration increases along two dimensions of the device.

11. The device according to claim 7 wherein each well includes an analyte sensor compound in a predefined concentration and the concentration of analyte sensor compound in two adjacent wells differs by a predefined amount.

12. The device according to claim 7 wherein the analyte is zinc and the analyte sensor is ZPP1.

13. The device according to claim 7 wherein the analyte is zinc and the analyte sensor is BG-29.

14. A test strip for detecting an analyte, the test strip comprising:
an elongated base;
a plurality of discrete sensor portions positioned in predefined locations along the base;
each sensor portion containing a predefined concentration of a sensor compound; and
wherein the sensor compound distinctly changes color at a predefined stoichiometric relationship with an analyte.

15. The test strip according to claim 14, wherein the concentration of the sensor compound in at least one sensor portion is different than the concentration of the sensor compound in at least one other sensor portion.

16. The test strip according to claim 14, wherein the plurality of discrete sensor portions are positioned substantially linearly along a portion base and the concentration of each of the sensor portions increases over at least one dimension of the base.

17. The test strip according to claim 15 further comprising an analyte permeable membrane covering at least one of the sensor portions.
